(19) United States
(12) Patent Application Publication
(10) Pub. No.: US 2016/0377800 A1
(43) Pub. Date: Dec. 29, 2016

(54) BACKLIGHT SYSTEM FOR LIQUID CRYSTAL DISPLAY DEVICES

(71) Applicant: Panasonic Liquid Crystal Display Co., Ltd., Hyogo (JP)

(72) Inventor: Takenori YAGUCHI, Hyogo (JP)

(21) Appl. No.: 14/747,812

(22) Filed: Jun. 23, 2015

(51) Int. Cl. F21V 8/00

(52) U.S. Cl. CPC G02B 6/0091; G02B 6/0068; G02B 6/0073; G02B 6/0083

(57) ABSTRACT

A liquid crystal display (LCD) panel and a backlight system for the LCD panel are provided. A light guide plate and an illumination source facing a side of the light guide plate are provided, wherein the illumination source comprises a set of light emitting diodes (LEDs). An LED substrate is provided on which the plurality of LEDs are mounted. A fixing plate is provided to which the LED substrate is attached. A set of clips are provided for binding the LED substrate and the fixing plate together.

### TECHNICAL FIELD

The present application relates to an LED substrate including a plurality of LEDs, a backlight unit including the LED substrate, and a liquid crystal display device including a liquid crystal display panel and the backlight unit that is disposed behind the liquid crystal display panel.

### BACKGROUND

A liquid crystal display (LCD) device is one example of display devices that are used as high-definition color monitors for computers and other information devices, and as television receivers. A liquid crystal display device fundamentally includes a display portion in which liquid crystals are sandwiched between two substrates at least one of which is made of transparent glass or the like.

An LCD display typically has a backlight unit that is disposed behind the liquid crystal display panel to project light onto the display panel. A side (edge) backlight unit is a kind of backlight unit, which includes a light guide plate having a plate shape that is made from a transparent material such as an acrylate resin, and a light source that includes a cold cathode tube (fluorescent lamp) or a set of Light-Emitting Diodes (LEDs) that are disposed along one side or more than one side of the light guide plate. The side backlight unit described here has an advantage in that a thin profile thereof can be easily achieved compared with a direct backlight unit including a light source disposed behind a liquid crystal display panel.

Typically, the set of LEDs are mounted on an LED substrate and the LED substrate is attached to a fixing plate by inserting screws into the LED substrate and the fixing plate. With rapid development in the technology, the number of LEDs used on an LED substrate is increasing and as a result the spaces between LEDs have to be decreased. However, screws inserted into the LED substrate may take up some of the space on the substrate and cause a need for an LED substrate with an increased width, which is not desirable. In addition, screw attachment does not allow any sliding flexibility between the LED substrate and the fixing plate. The lack of sliding flexibility may cause the LED substrate to bend, for example, due to the heat generated from the LEDs, and the bending may cause distortion of the light emitted from the

LEDs or breakage of the LED substrate. Therefore, a need exists for replacing the screw attachment with a more efficient attachment apparatus.

### SUMMARY

To address the above problems, an object of the present disclosure is to provide an LED substrate with a reduced width such that a depth of an LCD display device equipped with the LED substrate can be reduced.

Another object of the present disclosure is providing an attachment method and apparatus for attaching the LED substrate to a fixing plate of the LCD display such that the attachment provides sliding flexibility for the LED substrate and the fixing plate relative to each other to prevent light distortion from the LEDs.

In accordance with some aspects of the present disclosure, a backlight system is provided, which includes a light guide plate and an illumination source facing a side of the light guide plate. The illumination source includes a set of LEDs. The backlight system also includes an LED substrate on which the set of LEDs are mounted. The backlight system further includes a fixing plate to which the LED substrate is attached. The backlight system also includes a set of clips binding the LED substrate and the fixing plate together.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an exploded perspective view showing a schematic configuration of a liquid crystal display device, according to an embodiment of the present disclosure.

FIG. 2 is a cross-sectional view showing a relevant portion of the liquid crystal display device shown in FIG. 1 after being assembled.

FIGS. 3A-3B are exemplary diagrams showing configurations of conventional LED substrates of LCD display devices attached to fixing plates using screws.

FIGS. 4A-4D are exemplary diagrams showing a configuration of an LED substrate of an LCD display device, according to a first embodiment.

FIG. 5 is an exemplary diagram showing a configuration of an LED substrate of an LCD display device, according to a second embodiment.

FIGS. 6A-6E are exemplary diagrams showing a configuration of an LED substrate of an LCD display device, according to a third embodiment.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

A detailed description of an LED substrate, a backlight unit, and a liquid crystal display device of preferred embodiments of the present disclosure will now be provided with reference to the accompanying drawings.

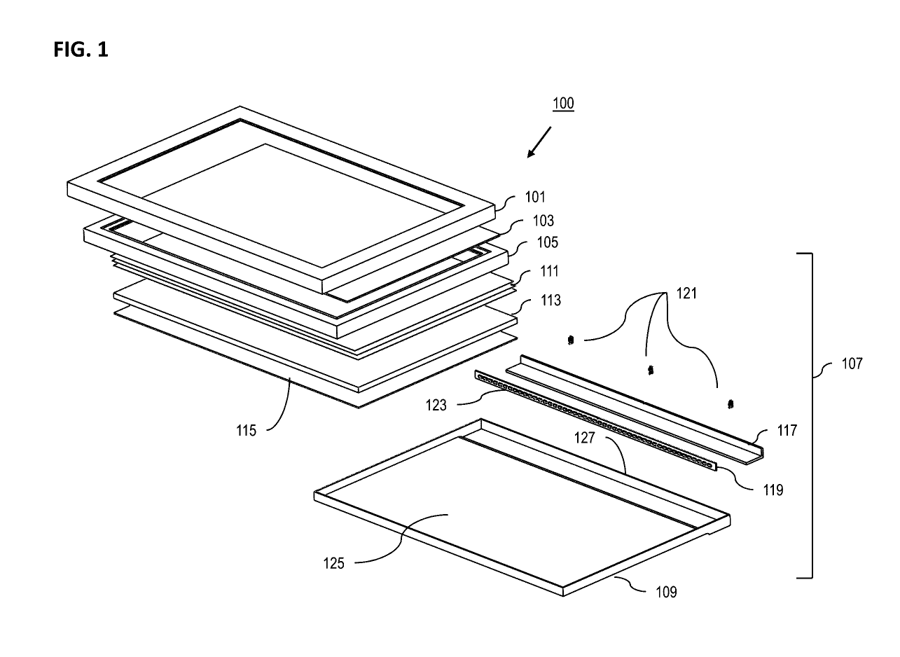

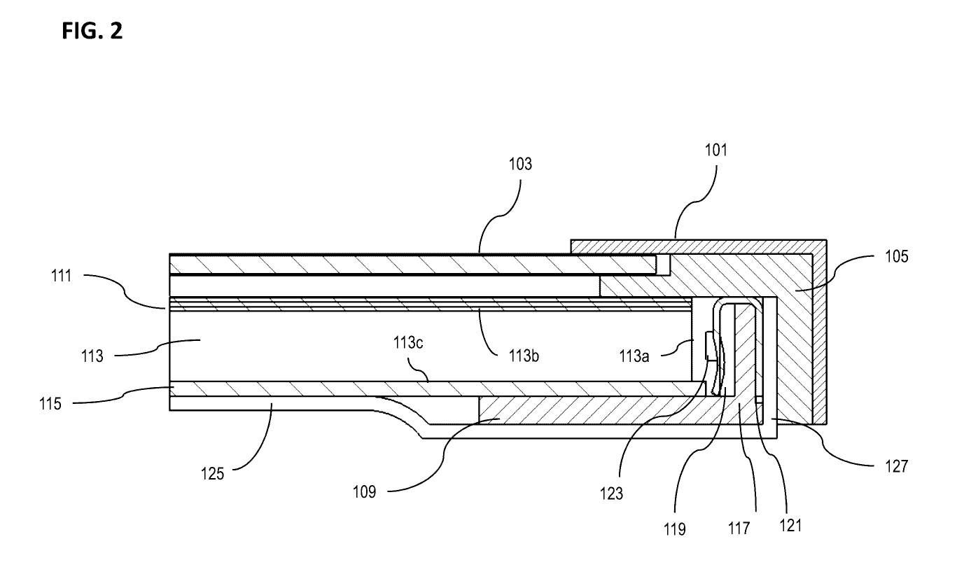

FIG. 1 is an exploded perspective view showing a schematic configuration of a liquid crystal display device, according to an embodiment of the present disclosure. FIG. 2 is an enlarged cross-sectional view showing a relevant portion of the liquid crystal display device 100. The liquid crystal display device 100 may include a bezel 101, a liquid crystal display panel 103 and a backlight unit 107 as shown in FIGS. 1 and 2. The bezel 101 may have a square frame shape with an opening so as to cover edge portions of the liquid crystal display panel 103, and can be arranged to, together with a backlight chassis 109 to be described later, ensure strength of the entire liquid crystal display device 100. The liquid crystal display panel 103 may include two glasses that are bonded together, and liquid crystals are filled in a space between the glasses. The liquid crystal display panel 103 is capable of displaying an image on its front surface.

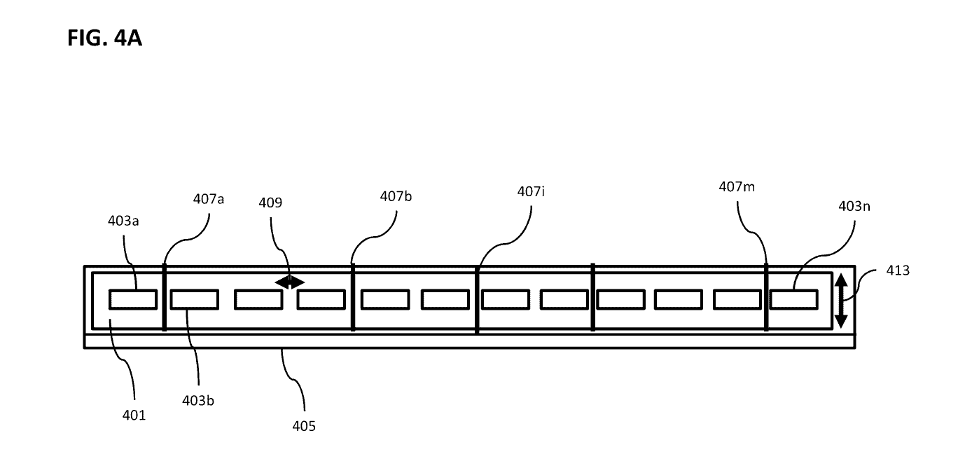

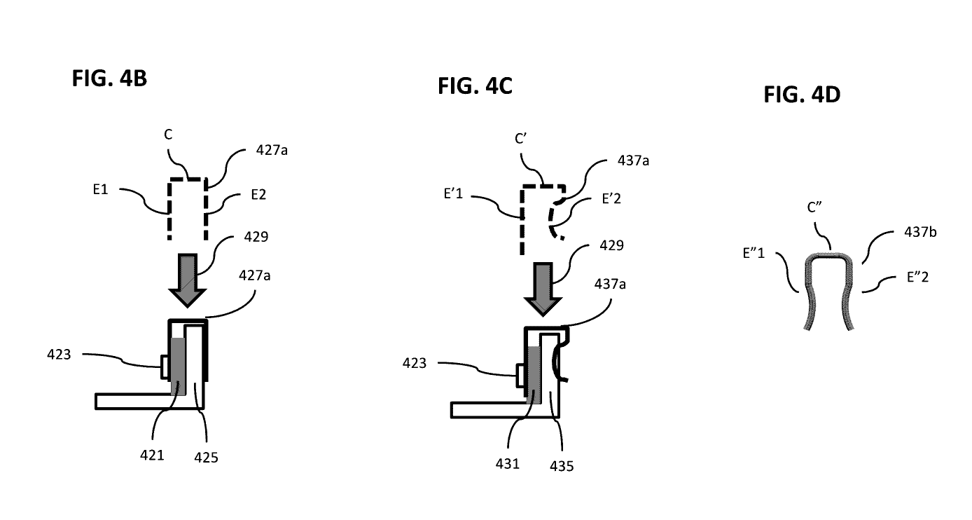

The backlight unit 107 defines a so-called side (edge) illuminating device. The backlight unit 107 may include a frame 105, optical sheets 111, a light guide plate 113, a reflection sheet 115, the backlight chassis 109, a fixing plate 117 (similar to fixing plates 405, 425, 435, 505, 605, and 625 of FIGS. 4A to 6E), and at least one LED substrate 119 (similar to LED substrates 401, 421, 431, 501, 601, and 621 of FIGS. 4A to 6E) as shown in FIG. 1. The LED substrate 119 is attached to the fixing plate 117 by binding members such as clips 121.

The frame 105 may have a square frame shape with an opening, and can be arranged to accommodate the optical sheets 111, the light guide plate 113 and the reflection sheet 115, which are stacked in this order from the top, to the backlight chassis 109. The optical sheets 111, the light guide plate 113 and the reflection sheet 115 define optical members arranged to adjust the optical properties (e.g., refraction, diffraction, reflection) of light that enters the liquid crystal display panel 103 from LEDs 123 included on the LED substrate 119.

The backlight chassis 109 can be made of a metal plate such as aluminum that possesses electrical conductivity. The backlight chassis 109 may have the shape of a box of low height that is formed through bending processing of the metal plate. The backlight chassis 109 houses the optical sheets 111, the light guide plate 113, the reflection sheet 115, the fixing plate 117, and the LED substrate 119.

The light guide plate 113 may have a rectangular shape when seen in a plan view, and can be made of a transparent plate having a thickness of about 3 to 4 mm. The light guide plate 113 includes a light incidence surface 113a arranged to receive light from the LEDs 123, and a light emitting surface 113b arrange to emit the light upward (in a direction to project the light) from the light incidence surface 113a. The light incidence surface 113a can be defined by a given side surface of the light guide plate 113, and the light emitting surface 113b can be defined by a front surface of the light guide plate 113.

The light guide plate 113 repeatedly and internally reflects the light, which enters from the light incidence surface 113a, between the light emitting face (front face) 113b and a back surface 113c, which is the opposite surface to the light emitting surface 113b, to planarly (e.g., in a two dimensional plane) diffuse the light inside the light guide plate 113. The light guide plate 113 includes a set of scattering members (not shown) on the back surface 113c, which are arranged to scatter the light, which enters from the light incidence surface (side surface) 113a, and emit the light from the light emitting surface (front surface) 113b. The scattering members are preferably provided thereon by dotting paint containing a white pigment in a printing method on the back surface 113c of the light guide plate 113, or are preferably provided thereon by forming a set of concave portions on the back surface 113c of the light guide plate 113.

In addition, the LEDs 123 provided to the LED substrate 119 can be disposed close to the light incidence surface 113a of the light guide plate 113. Further, light emitting surfaces of the LEDs 123 are disposed along the light incidence surface 113a of the light guide plate 113, having a given space therebetween so as to be opposed to the light incidence surface 113a. The LED substrate 119 can be fixed so as to be disposed laterally while standing (erecting) on the fixing plate 117 having the shape of the letter “L” that can be provided so as to stand on a bottom plate 125 in the vicinity of a side wall 127 of the backlight chassis 109.

The reflection sheet 115 can be disposed so as to cover the back surface 113c, which is the opposite surface to the light emitting surface 113b. The reflection sheet 115 may be disposed on the bottom plate 125 of the backlight chassis 109. The reflection sheet 115 can be arranged to reflect the light, which is emitted from the back surface 113c of the light guide plate 113, toward the light guide plate 113. The reflection sheet 115 may define a resin sheet having a thickness of about0.1 to 2 mm. The reflection sheet 115 may be painted white to increase the use efficiency of the light and to enhance brightness of the light on the light emitting surface 113b of the light guide plate 113 by efficiently reflecting the light, which is emitted from the back surface 113c of the light guide plate 113, toward the light guide plate 113.

The optical sheets 111 include resin sheets, which have a thin rectangular shape when seen in a plan view. The optical sheets 111 are defined by a stack of the polarization selective reflection sheet, the lens sheet, and the diffusion sheet, which may have a thickness of about 0.1 to 0.5 mm, and are stacked in this order from the top and disposed on the light guide plate 113.

The diffusion sheet may be used to diffuse the light emitted from the light guide plate 113, allowing uniform brightness distribution of the light. The lens sheet can be used to gather the light emitted from the diffusion sheet, allowing enhancement of front brightness of the light. The polarization selective reflection sheet can be used to selectively reflect the light emitted from the lens sheet so that the light is not absorbed by a polarizing plate (not shown) that can be attached on the underside of the liquid crystal display panel 103.

The backlight unit 107 may be capable of converting the light from the LEDs 123 into flattened light with the use of the optical sheets 111, the light guide plate 113 and the reflection sheet 115, and projecting the light onto a back surface of the liquid crystal display panel 103.

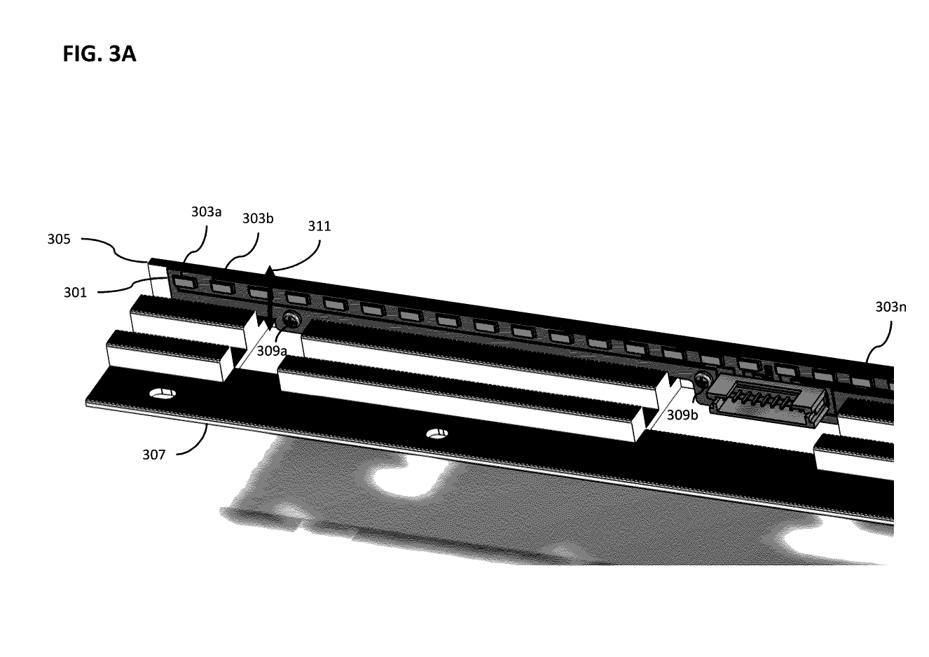

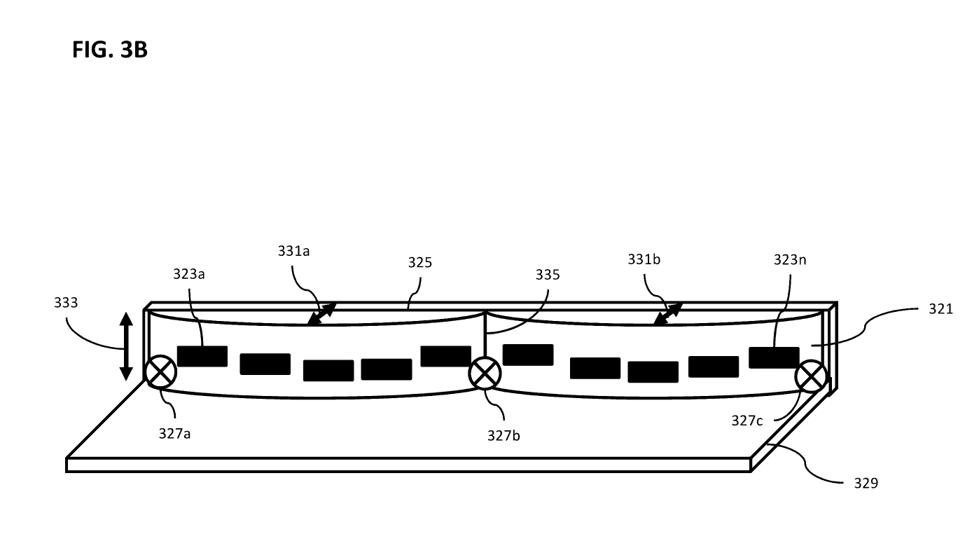

FIGS. 3A-3B are diagrams showing configurations of conventional LED substrates of LCD display devices attached to a fixing plate using screw. FIG. 3A is a diagram of an LED substrate 301 with LEDs 303a, 303b, to 303n (303a-303n). The LED substrate 301 is attached to a fixing plate 305 of heat sink 307 with a set of screws such as 309a and 309b. As the number of LEDs 303a-303n on the LED substrate 301 increases, the available space between the LEDs 303a-303n for fitting the screws to attach the LED substrate 301 to the fixing plate 305 decreases. This problem may be solved by providing the screws below or above the LED line on the LED substrate 301. For example, in FIG. 3A the screws 309a and 309b are provided below the LED line 303a-303n. This solution, however, may cause the width 311 of the LED substrate to increase, which is not desirable because it leads to a thicker LCD display device. The thickness of the LCD device depends on the thickness 313 of the fixing plate 305.

FIG. 3B is diagram of another conventional LED substrate 321 with LEDs 323a-323n. The LED substrate 321 is attached to a fixing plate 325 of heat sink 329 with a set of screws 327a, 327b and 327c. As seen in FIG. 3B, the screws 327a, 327b, and 327c may cause the width 333 of the LED substrate 321 to increase to provide enough space for screws 327a-327c on the substrate 321. However, an increase of width 333 may cause the width of the fixing plate 325 to also increase and as a result a total depth of the heat sink 329. Moreover, as shown in FIG. 3B, the substrate 321 may deform or expand, for example, due to the heat generated from the LEDs 323a-323n. Upon expansion of the LED substrate 321 and because the screws 327a-327c do not allow the substrate 321 to slide relative to the fixing plate 325, the lack of sliding flexibility may cause the substrate 321 to bend relative to the fixing plate 325 and cause creation of gaps such as 331a and 331b between the LED substrate 321 and the fixing plate 325. The bending of the LED substrate 321 may cause distortion of the lights generated from the LEDs 323a-323n. In addition, the bending may cause breakage of the LED substrate 321, as for example seen in line 335.

FIGS. 4A-4D are exemplary diagrams showing a configuration of an LED substrate of an LCD display device, according to a first embodiment. FIG. 4A is an exemplary diagram of an LED substrate 401 with LEDs 403a-403n. The LED substrate 401 is attached to a fixing plate 405 with a set of clip shaped fixing members 407a, 407b, . . . , and 407m (407a-407m). The fixing members (e.g., clips) 407a-407m can attach the LED substrate 401 to the fixing plate 405 such that a clip is located within a gap 409 between two adjacent LEDs, for example between 403a and 403b of the LEDs 403a-403n on the LED substrate 401. The width of a clip 407a-407m is narrower than the gap 409 between the two adjacent LEDs from the LEDs 403a-403n on the LED substrate 401. FIG. 4B shows a side view of the structure of FIG. 4A.

In FIG. 4B the fixing plate 425 corresponds to the fixing plate 405, the LED substrate 421 corresponds to the LED substrate 401 and the LED 423 corresponds to the LEDs 403a-403n of FIG. 4A. The clip 427a is similar to the clips 407a-407m from FIG. 4A. As shown in FIG. 4B, the fixing plate 425 and the LED substrate 421 can be attached together by clip 427a, where the clip 427a can slide into place in a direction shown with arrow 429 and hold the fixing plate 425 and the LED substrate 421 together. The embodiment discussed above can reduce the width 413 of the LED substrate 401 (shown in FIG. 4A) by omitting the space needed for the screws shown in FIGS. 3A-3B and as a result provide an LCD display with a smaller depth compared to the LED substrates of FIGS. 3A-3B. As shown in FIG. 4B the clip 427a can have a concave U-shape with a center portion C and two straight edge portions E1 and E2.

FIG. 4C shows a side view similar to FIG. 4B where the clip 437a is similar to clip 427a with a different shape such that clip 437a has a center portion C′, a straight edge E′1 and an edge E′2 with a convex U-shape. The convex U-shape of edge E′2 of clip 437a can increase pressure for a firm grip between the LED substrate 431 and the fixing plate 435 (similar to the LED substrate 421 and the fixing plate 425 of FIG. 4B, respectively). Alternatively, as shown in FIG. 4D, a clip 437b, similar to clips 427a or 437a, can have a shape with a center portion C″, and two convex U-shape edges E″1 and E″2.

In various aspects, a combination of clips 427a, 437a, and 437b having different shapes may be used for attaching the LED substrate 401 and the fixing plate 405 of FIG. 4A. For example, at least one clip 437b and at least two clips 437a can be used such that the at least one clip 437b provides firm attachment between the LED substrate 401 and the fixing plate 405 and the at least two clips 437a can provide a sliding attachment such that the fixing plate 405 can freely slide relative to the LED substrate 401. The clip 437b can be mounted between the clips 437a. For example, the at least one clip 437b can be attached at the center of the LED substrate 401 (at location 407i) to firmly attach the LED substrate 401 to the fixing plate 405. The clips 407a and 407m, for example, can be of a shape similar to clip 437a to allow the fixing plate 405 to slide relative to the LED substrate 401. The remaining clips can have either the 437a or the 427a shapes. It is noted that clips 437a and 437b may allow sliding of the LED substrate with respect to the fixing plate. However, the sliding of the LED substrate 401 relative to the fixing plate 405 at location 407i where clip 447b is used is minimal while sliding at locations where the at least two clips 437a are used is enough to prevent deforming or bending of the LED substrate 401.

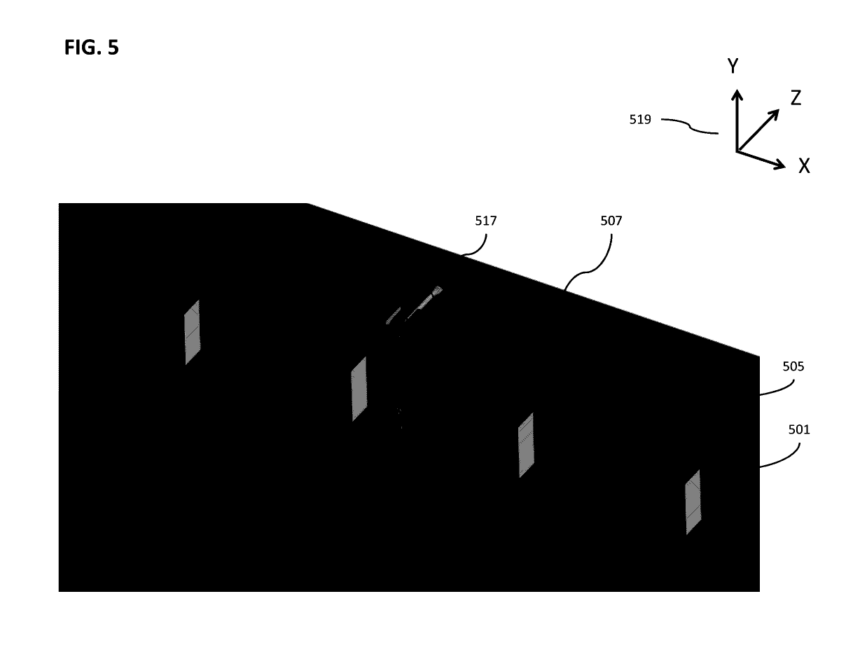

FIG. 5 is an exemplary diagram showing a configuration of an LED substrate of an LCD display device, according to a second embodiment. FIG. 5 shows a portion of an LED substrate 501 similar to the LED substrate 401 of FIG. 4A, with LEDs 503a-503d similar to LEDs 403a-403n. The LED substrate 501 is attached to a fixing plate 505, similar to the fixing plate 405 of FIG. 4A, with a set of clips 509. The set of clips 509 can include any of the shapes 427a, 437a and 437b as described in FIGS. 4B-4D. The LED substrate 501 and the fixing plate 505 are attached to a back frame 507. Only one clip 509 is shown in FIG. 5.

In one aspect of the present application, the LED substrate 501 may include a set of lateral grooves, for example, groove 511 such that a clip 509 can be engaged within the groove 511. In addition, or alternatively, the fixing plate 505 may also include a set of vertical grooves, for example, groove 515 to engage with clip 509. In some aspects, the width 513 of a groove 511, or the width 517 of a groove 515 can be substantially the same as or slightly larger than the width of a clip 509, such that the clip 509 can tightly fit into the groove 515. The width 517 of a groove 515 is considered to be substantially the same as the width a clip 509, if, for example, the width of groove 515 is up to about 5% larger than the width of clip 509. The 5% larger width may be applied for the clip to fit inside the groove. In other aspects, the width 513 of a groove 511 or the width 517 of a groove 515 can be greater than the width of a clip 509, to allow flexibility. For example, the width 513 of a groove 511 or the width 517 of a groove 515 can be twice as wide as the width of clip 509 or larger to allow the fixing plate 505 to slide relative to the LED substrate 501.

For example, when the width 513 of groove 511 is substantially the same as or slightly larger than the width of clip 509, the groove 511 prevents the LED substrate 501 from moving in the X direction relative to the fixing plate 505, as shown in the three dimensional axis 519. As another example, when the width 517 of groove 515 is greater than the width of clip 509, or greater than the width 513 of groove 511, the groove 515 allows the fixing plate 505 to move in the X direction relative to the LED substrate 501. For example, the width 517 of groove 515 can be 30% to 50% larger than the width of groove 511 to allow the fixing plate 505 to move in X direction.

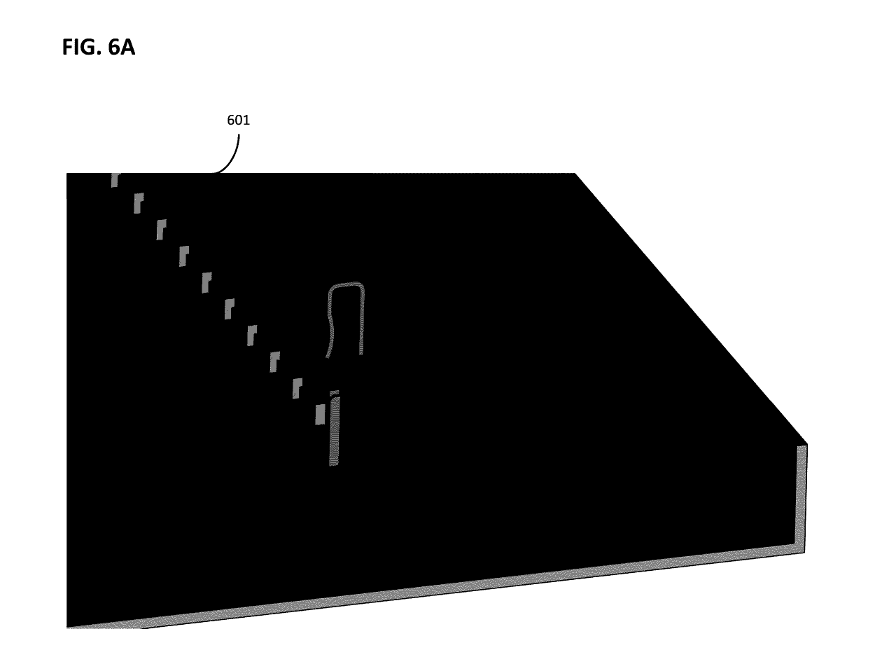

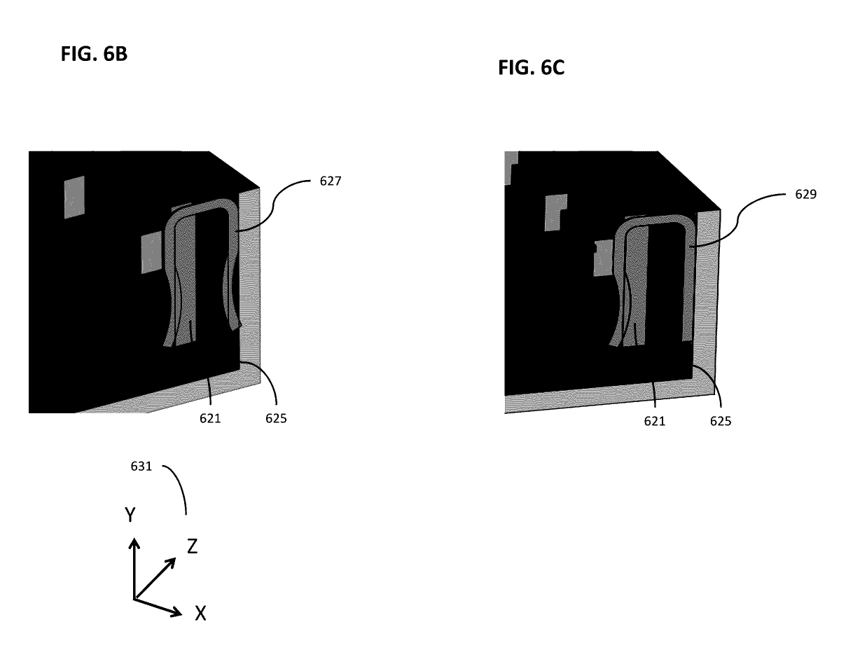

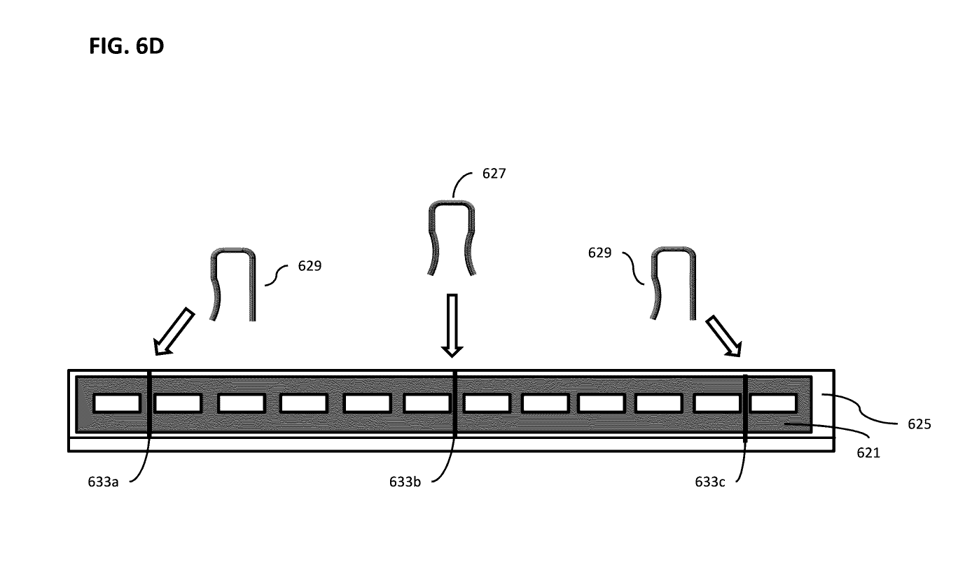

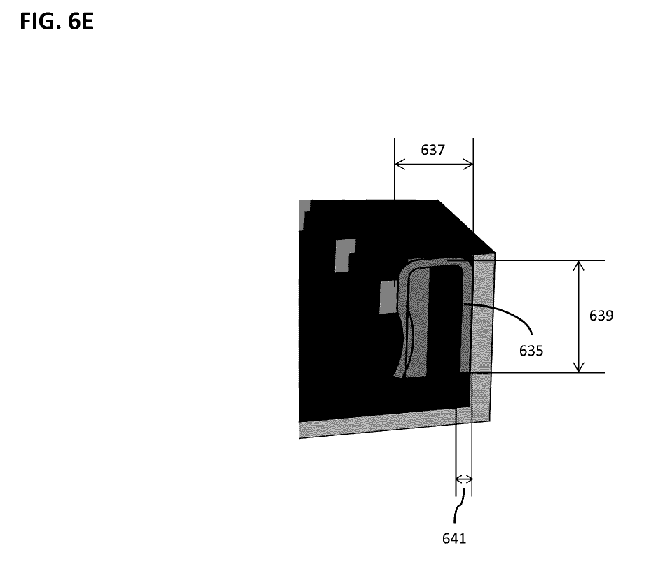

FIGS. 6A-6E are exemplary diagrams showing a configuration of an LED substrate of an LCD display device, according to a third embodiment of the present disclosure. As discussed with respect to FIGS. 4B-4D, in some aspects, a clip (427a, 437a, or 437b) can have a concave U-shape with a center portion (C, C′ or C″) and two edge portions (E1, E′1 or E″1) and (E2, E′2 or E″2). Each of the edges E1, E′1 or E″1 and E2, E′2 or E″2 can have a convex U-shape.

As shown in FIG. 6A, in some aspects, at least one of the grooves 609, similar to groove 511 of FIG. 5, or at least one of the grooves 611, similar to groove 515 of FIG. 5, are shaped similar to the shape of a clip 427a, 437a or 437b to engage with the clip. For example, the groove 609 can be shaped similar to clip 607 such that the convex U-shaped edge of clip 607 can be engaged with the convex U-shaped groove 609. Similarly, groove 611 can be shaped similar to the straight edge of clip 607 to engage with the straight edge.

In some cases, at least two clips shaped similar to clip 607 are used, such that the clip has a concave U-shape with a center portion and two edge portions, when one of the edge portions has a convex U-shape and other edge portion has a straight shape. In such cases, at least two grooves 609 and at least two grooves 611 corresponding to the grooves 609 are shaped according to the shape of clip 607 to engage with the at least two clips 607. Corresponding grooves on an LED substrate 601 and a fixing plate 605 are grooves that are co-located when the LED substrate 601 and the fixing plate 605 are attached to each other.

As shown in FIG. 6B, the LED substrate 621 and the fixing plate 625 are attached together using clip 627. Clip 627, similar to clip 437b of FIG. 4D, has a concave U-shape with a center portion and two edge portions, where both of the edge portions have a convex U-shape. In FIG. 6C, the LED substrate 621 and the fixing plate 625 are attached together using clip 629. Clip 629, similar to clip 437a of FIG. 4C, has a concave U-shape with a center portion and two edge portions, where one of the edge portions has a convex U-shape and the other edge portion has a straight shape.

In the example of FIG. 6D, at location 633b a clip 627 is used to attach the LED substrate 621 and the fixing plate 625. However, at locations 633a and 633c the LED substrate 621 and the fixing plate 625 are attached together using clips 629. In this example, both of the LED substrate 621 and the fixing plate 625 have grooves shaped similar to the clips attaching them together. For example, at location 633b the front (LED substrate 621) and the back (fixing plate 625) have concave grooves where the convex edges of clip 627 are attached. Similarly, in locations 633a and 633c the LED substrate 621 has a concave groove while the fixing plate 625 has a straight groove to fit the edges of clip 629.

The clip 627 prevents the LED substrate 621 and the fixing plate 625 from sliding relative to each other in a Y direction or in an X direction of the dimensional axis 631. The clips 629 prevent the LED substrate 621 and the fixing plate 625 from sliding relative to each other in a Y direction of the dimensional axis 631, however, the clips 629 allow the LED substrate 621 and the fixing plate 625 to slide relative to each other in an X direction of the dimensional axis 631.

In the example of FIG. 6E dimensions of a clip 635 similar to clips 627 and 629 of FIGS. 6B-6D are shown. As shown in FIG. 6E, the width 637 of clip 635 can be between 3 to 6 millimeters. The length 639 of clip 635 can be between 5 to 10 millimeters, and the thickness 641 of clip 635 can be between 0.5 to 1.5 millimeters. It is noted that the dimension ranges may change depending on the size of the LED substrate (shown as 609 in FIG. 6A), the size of the LEDs (shown as 503a in FIG. 6A), the size of the fixing plate (shown as 605 in FIG. 6A), or in general to the size of the liquid crystal display device 100 of FIG. 1.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A backlight system comprising:
a light guide plate and an illumination source facing a side of the light guide plate, wherein the illumination source comprises a plurality of light emitting diodes (LEDs);
an LED substrate on which the plurality of LEDs are mounted;
a fixing plate to which the LED substrate is attached; and
a plurality of clips binding the LED substrate and the fixing plate together.

2. The backlight system of claim 1, wherein a width of a clip of the plurality of clips is smaller than a distance between two adjacent LEDs of the plurality of LEDs.

3. The backlight system of claim 1, wherein a clip of the plurality of clips has a concave U-shape having a center portion and two straight edge portions.

4. The backlight system of claim 1, wherein at least one first clip of the plurality of clips has a concave U-shape with a center portion and two edge portions, each of the edge portions having a convex U-shape, and
wherein at least two second clips of the plurality of clips each has a concave U-shape with a center portion and two edge portions, one of the edge portions having a convex U-shapes and other edge portion having a straight shape.

5. The backlight system of claim 4, wherein the at least one first clip is mounted between the at least two second clips.

6. The backlight system of claim 5, wherein the at least one first clip is mounted at a center of the LED substrate.

7. The backlight system of claim 1, wherein:
the LED substrate includes a plurality of first grooves engaged with the plurality of clips, respectively, and
the fixing plate includes a plurality of second grooves engaged with the plurality of clips, respectively.

8. The backlight system of claim 7, wherein:
a width of a first groove of the plurality of first grooves is substantially the same as a width of a clip of the plurality of clips, engaged with the first groove, and
a width of a second groove of the plurality of second grooves, engaged with the clip is greater than the width of the first groove.

9. The backlight system of claim 7, wherein:
a width of a first groove of the plurality of first grooves is greater than a width of a clip of the plurality of clips, engaged with the first groove, and
a width of a second groove of the plurality of second grooves, engaged with the clip is substantially the same as the width of the clip.

10. The backlight system of claim 7, wherein:
a width of a first groove of the plurality of first grooves is substantially the same as a width of a clip of the plurality of clips, engaged with the first groove, and
a width of a second groove of the plurality of second grooves, engaged with the clip is substantially the same as the width of the first groove.

11. The backlight system of claim 7, wherein:
a width of a first groove of the plurality of first grooves is greater than a width of a clip of the plurality of clips, engaged with the first groove, and
a width of a second groove of the plurality of second grooves, engaged with the clip is substantially the same as the width of the first groove.

12. The backlight system of claim 7,
wherein at least one first clip of the plurality of clips has a concave U-shape with a center portion and two edge portions, each of the edge portions having a convex U-shape, and
wherein at least one of the plurality of first grooves and at least one of the plurality of second grooves are shaped to engage with the at least one first clip.

13. The backlight system of claim 12,
wherein at least two second clips of the plurality of clips each has a concave U-shape with a center portion and two edge portions, one of the edge portions having a convex U-shape and other edge portion having a straight shape, and
wherein at least two of the plurality of first grooves and two of the plurality of second grooves are shaped to engage with the at least two second clips.

14. The backlight system of claim 13,
wherein the at least one first clip causes the LED substrate and the fixing plate to be substantially motionless relative to each other along a direction of a length of the LED substrate and along a perpendicular direction to the length of the LED substrate, and
wherein the at least two second clips cause the LED substrate and the fixing plate to be sliding relative to each other along the direction of the length of the LED substrate.

15. A liquid crystal display (LCD) panel including the backlight system of claim 1.
